(19) United States
(12) Patent Application Publication
(10) Pub. No.: US 2026/0028158 A1
(43) Pub. Date: Jan. 29, 2026

(54) EVENT ACTIVATED CONTROLS AND DISPLAY FOR A SHIPPING CONTAINER

(71) Applicant: Jorge Sanchez-Olea, Poway, CA (US)

(72) Inventor: Jorge Sanchez-Olea, Poway, CA (US)

(21) Appl. No.: 19/184,410

(22) Filed: Apr. 21, 2025

Related U.S. Application Data
(63) Continuation of application No. 18/212,082, filed on Jun. 20, 2023, now abandoned.
(60) Provisional application No. 63/353,868, filed on Jun. 21, 2022.

(51) Int. Cl. B65D 33/00; B65D 25/02

(52) U.S. Cl. CPC B65D 33/004; B65D 25/02; B65D 2203/10; B65D 2401/00

(57) ABSTRACT

An apparatus and a method to be used for secured shipment of goods while monitoring location and status with one or more sensors embedded in the package of the shipment container. The apparatus is operated in sleep mode is used to preserve battery power and is activated to report sensor status by means of a touch sensitive pad or switch. Reporting of sensor status may be done with color code messages of various LED blinking messages and/or by wireless means that may include location.

### RELATED APPLICATIONS

This application claims priority to U.S. application Ser. No. 18/212,082 filed Jun. 20, 2023, which application claims priority to U.S. Provisional Application 63/353,868 filed on Jun. 21, 2022. The entire disclosures of all the related applications set forth in this section are hereby incorporated by reference in their entireties.

### BACKGROUND

Shipping containers used in transportation of goods are vulnerable to a multiplicity of problems. A widespread problem is the intrusion by someone into the container to replace the goods shipped for less valuable goods and counterfeits. Other issues can be present when the goods shipped exhibit sensitivity to extreme temperatures which can cause the goods to spoil or degrade. It is possible to breach a shipping package through the walls of the container, which causes a breakdown of the shipment quality and places doubts on the authenticity of the shipped goods. Goods such as pharmaceuticals have an expiration date, and therefore, for the medications to be effective, there needs to be a time stamp on the package. Other goods have a high monetary value, such as jewelry, perfumes, wine, clothing. Critical legal documents are also shipped through the mail system and need to be protected. Art items such as paintings and sculptures need to be shipped securely, on time and without exposure to extreme ambient conditions. In the case of critical electronics, if substituted by counterfeit parts and placed in the military supply chain, there is the possibility that the parts can cause loss of life and jeopardize national security.

Efforts to address these problems include the utilization of Radio Frequency Identification (RFID) tags. These tags are useful for tracking materials during shipment, but they only track the shipment and do not protect the authenticity or monitor environmental conditions that can affect the articles in a shipment. The presently used RFID tags will not always monitor the shipment during transportation and will not by themselves include sensors to determine if environmental conditions are such that the goods may have been damaged in transit.

There have been proposed solutions that include attaching a set of conductors inside of packages to form an antenna which can respond to an external radio frequency monitoring receiver used to verify the antenna is intact inside of the container. The proposed idea is that this type of configuration will ensure the items inside a shipping container will be secured from tampering and will also maintain quality. This approach is not practical since it is not possible to have frequency monitoring receivers at all locations where the monitors can check the shipping package throughout the geographical travel of the goods. There is also no way to protect all the internal surfaces of the package from intrusion by placing dense conductors while still forming an effective radio antenna. Furthermore, with this approach, RF antennas must be individually placed and tuned for each type of package and tuned to a nearby monitoring receiver frequency. This approach makes the proposed solution costly and not practical for industry to be used as a solution to monitor and protect the health and authenticity of the shipped goods.

It should be noted that this Background is not intended to be an aid in determining the scope of the claimed subject matter nor be viewed as limiting the claimed subject matter to implementations that solve any or all of the disadvantages or problems presented above. The discussion of any technology, documents, or references in this Background section should not be interpreted as an admission that the material described is prior art to any of the subject matter claimed herein.

### SUMMARY

In one implementation, a shipping container comprises a body and one or more sensors coupled to the body, wherein the one or more sensors comprise an intrusion sensor. The shipping container also comprises an electronics monitoring unit coupled to the one or more sensors. The electronics monitoring unit is configured to transition from a low power operational mode in response to an event detected by at least one of the one or more sensors.

In another implementation, a method of monitoring a status of a shipping container comprises coupling one or more sensors to the shipping container and coupling the one or more sensors to an electronic monitoring unit. In a low-power mode of the electronic monitoring unit, monitoring one or more outputs from the one or more sensors, and in response to an event detected via at least one of the one or more outputs, transitioning from the low-power mode to a higher power mode.

It is understood that various configurations of the subject technology will become apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

### BRIEF DESCRIPTION OF THE DRAWINGS

Various embodiments are discussed in detail in conjunction with the Figures described below, with an emphasis on highlighting the advantageous features. These embodiments are for illustrative purposes only and any scale that may be illustrated therein does not limit the scope of the technology disclosed. These drawings include the following figures, in which like numerals indicate like parts.

FIG. 1 is a diagram of a secured shipping container in accordance with some embodiments.

FIG. 2 is a block diagram/schematic of control electronics that may be associated with a secured shipping container in accordance with some embodiments.

FIG. 3a illustrates a container comprising control electronics with a touch sensitive switch and LED or other type of visual indicator.

FIG. 3b illustrates a lid for the container of FIG. 3a.

FIG. 4 is an embodiment of a secured shipping container implemented with a bag with printed conductive material with the use of touch sensitive detectors, low power sensors, and indicators.

### DETAILED DESCRIPTION

The following description and examples illustrate some exemplary implementations, embodiments, and arrangements of the disclosed invention in detail. Those of skill in the art will recognize that there are numerous variations and modifications of this invention that are encompassed by its scope. Accordingly, the description of a certain example embodiment should not be deemed to limit the scope of the present invention.

Implementations of the technology described herein are directed generally to systems, devices, and processes for monitoring a shipping container to determine status regarding tampering, intrusion, and exposure to various environmental conditions. Included is an apparatus that may contain one or more of an electrical pattern used as a sensor for tampering, environmental sensors, geolocation and communication features, and a process consisting of a touch activated sensor test, security features, communication systems, geolocation, and a status display. All these features can allow protection of a shipping container from intrusion on any one or more or all its sides, as well as collection of environmental information during shipment and remote monitoring. Embodiments disclosed herein address the above-stated needs to protect goods shipped to consumers and industry from damage due to environmental conditions and from replacement with low quality substitutes, or counterfeits.

Embodiments of the present technology include an arrangement of a protection layer and a set of sensors to ensure the shipped goods are safe, authentic, and not damaged. The protection is done on a continuous basis during shipment and during travel over different geographical locations. The invention uses sensors, processors for electronic monitoring and includes means of communication. Multiple sensors can be embedded in the shipping container. Sensors can include wire, optical fiber, or conductive ink made of various chemical mixtures, including carbon, silver and other materials as needed for the specific application. In addition, other materials such as partially conductive material, thin conductive film, semiconductors, an assortment of pressure temperature, friction, capacitance, humidity, optical and other sensors in general can be included as needed to monitor the security of the shipment, quality, and environmental stress on the shipped goods.

In addition, this invention can use location methods to determine GPS coordinates and can integrate any of the available set of communication interfaces such as Wi-Fi, RFID, Bluetooth, LoRaWAN, and Cell to continuously report status to a remote monitoring service using any of the Mobile communications (cell) infrastructure. Communication for monitoring purposes can be automatically done to inform security personnel of sensor status located nearby using Bluetooth, Wi-Fi, or RFID.

The RFID capability can also be used as the means for storing in the RFID memory additional security, serial numbers, source and destination of shipment, tracking, and sensor information in the shipping package to be used for later review.

In applications where tampering protection is necessary, the tampering sensor can be implemented with a pattern of embedded wire in such a way that the cutting of the wire is detected by a processor and interpreted as an attempt to enter the container and have access to the goods targeted for shipment. The wire can be of fine gage so that it can be disguised within the inner layers of the container package and can be placed around the container as dense as it is needed to prevent intrusion. Also, wire can be placed in a mesh configuration with a density high enough to prevent access.

Security and authentication to prevent forgery of the container itself or the goods inside can be obtained with the use of encrypted data with the addition of a token or a pedigree in the RFID memory at the point of shipment. It is also possible to include an internal pedigree in the container of this invention by using physical parameters measured by the sensors, or data from random number generators, or a digitized analog component signature with unique characteristics.

A significant challenge in shipping containers for consumer and industrial use is cost and environmental concerns. Typical shipping containers use paper and cardboard which are inexpensive and biodegradable. To implement all the functions previously described, this invention discloses ways to embed in those types of inexpensive materials the sensors as well as all the needed functionalities with the appropriate manufacturing techniques. These techniques can be implemented with assembly tooling ranging from simple hand tools, and with various degrees of highly automated machinery.

The manufacturing implementation can be done using circuits, batteries, electronic components printed directly on the substrate used, which can be made of plastics or other convenient substrate as needed to achieve the cost effectiveness of mass production for high volumes. The physical look of the protected container in this invention can be a shipment packaging material where the sensors are embedded in the material in a way that the sensors surround the goods to be shipped and are not easily visible. It is anticipated that the solution can be applied to shipping packages such as pallets of goods using the appropriate scaling measures with the sensors.

For a remote monitoring secure application, the method used can be for the controller to send a data package with the sensor information to a server in a cloud installation using any of the various means of wireless communication. For example, a Wi-Fi portal connection, or if the means of communication to a server is the use of Cell, then a wireless cell communication modem can be used. For applications where the receiver person of the shipment needs to be notified, appropriate access to the receiver of the goods can be provided using email or by sending a text message to the receiver person's cell phone.

One challenge with remote monitoring of secured containers is the fact they operate with batteries which degrade and discharge over time. Batteries are used to provide power to the electronic components used to monitor the shipping containers. To save power, the electronics may be turned off at times to lengthen the time the shipment is monitored. This approach prevents the electronics from continually monitoring the sensors used to protect the container which reduces the effectiveness of the security shipment container. To address this issue, some embodiments of the invention comprise an electronics architecture where extremely low power controllers are used, and which are operated in deep sleep mode. This operation of the controller is used in combination with sensors that require little to no power. The sensors will activate the controller and cause it to transition from a low power mode to a higher power mode, e.g. “wake up” from deep sleep if an anomaly or change is detected and transmitted by the sensor. At that time, the controller will then analyze the sensor information event to determine if unacceptable levels of signals from the sensors have occurred, which would merit appropriate action to be taken.

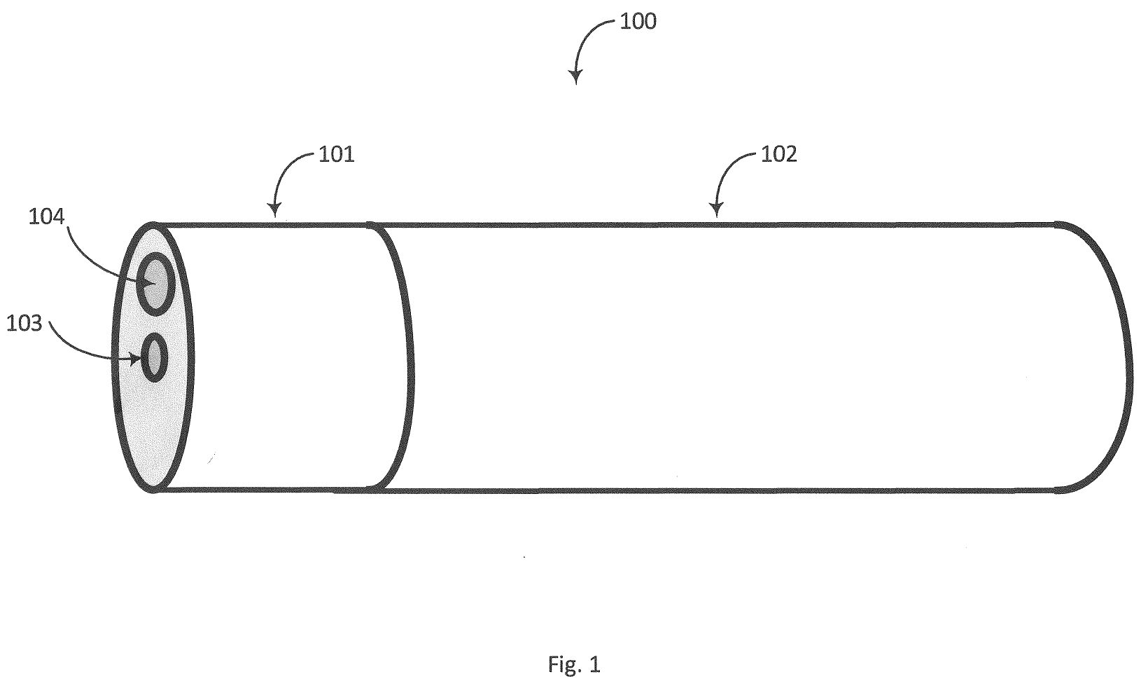

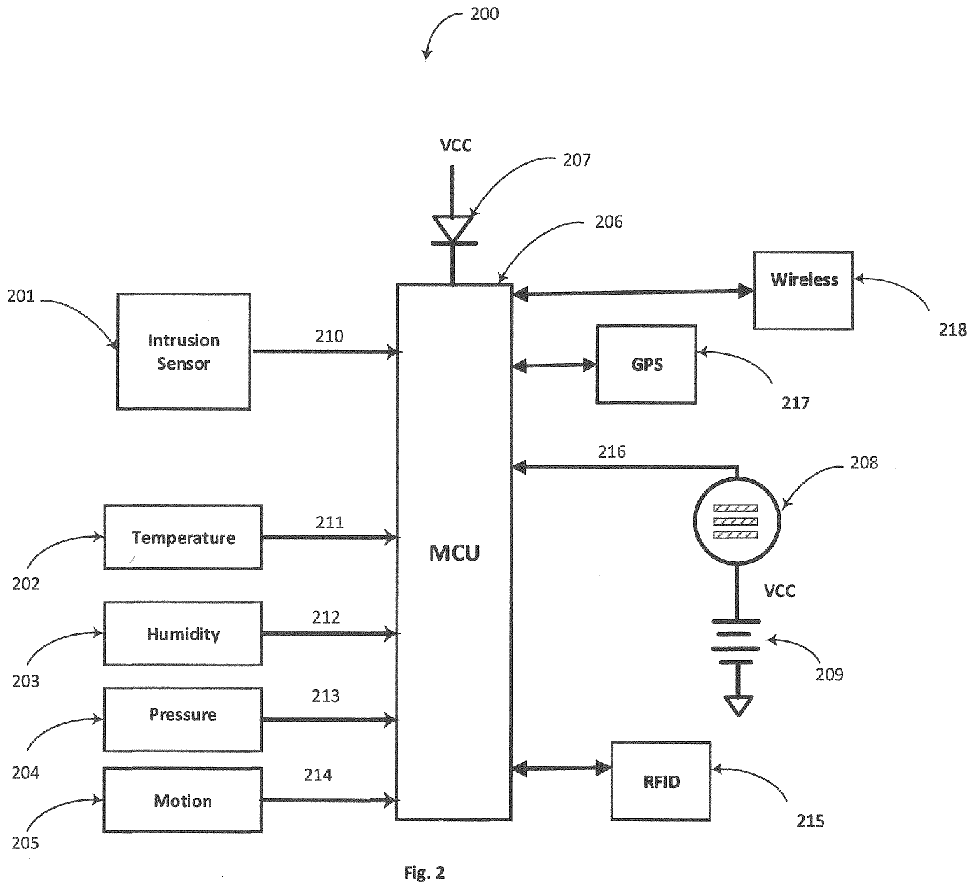

FIG. 1 shows an exemplary embodiment of a secured shipping container. The entire periphery of the container is secured using a sensor used to detect intrusion. The sensor can be a wire mesh around the outside of the container or with another type of conductor placed on the outside as described in US Patent Publication 2023/0130945 entitled SECURE SHIPMENT CONTAINER AND RELATED METHODS, the entire disclosure of which is incorporated by reference herein in its entirety with particular reference to FIGS. 1a, 1b, 2a, and 2b as example containers with intrusion detection capabilities. FIG. 1 shows the shipping container after a cap 101 has been placed on a cylinder 102 to secure the goods placed inside of the container. The cap 101 further illustrates an LED indicator opening 103 and a status reporting activation opening 104. The cap 101 contains a Electronics Monitoring Unit. Specific embodiments of these features are described in more detail below.

FIG. 2 shows the elements of an exemplary electronics monitoring unit (EMU) 200. The EMU 200 contains multiple sensors such as an intrusion sensor 201, temperature sensor 202, humidity sensor 203, pressure sensor 204, motion, acceleration, and shock sensor 205. Furthermore, the electronics monitoring unit 200 contains a status reporting activation sensor 208, a battery 209, one or more LED or other type of visual indicators 207, an MCU controller 206. Additional elements may be included in the Electronics Monitoring Unit 200 such as an RFID 215, a wireless communications channel 218, which can consist of cell, LoRaWAN, Wi-Fi or Bluetooth. In addition, geolocation devices 217 can also be included. In this invention disclosure we will focus on the event activated features which are used to provide power savings operation.

There are new technological developments in sensors that allow the sensor to utilize little power consumption in the order of hundreds of picoamps. In this invention we use a multitude of sensors with this type of power consumption.

One sensor of special interest is the intrusion sensor 201. This sensor can be a mesh of wire such that one side is connected to a power supply and the other end of the mesh is connected to the MCU controller 206. The controller 206 can be placed in a deep sleep mode of operation. If the controller pin is sensing a voltage near the power supply battery 209 voltage, it will remain in deep sleep with negligible power consumption in the order of a microamp. If the wire mesh sensor 201 is cut by an intruder, then the controller 206 pin will not detect a logic high voltage, and by using a pulldown resistor, the circuit will become a logic low which then will trigger an interrupt that will wake up the MCU controller 206 and set it in processing more to analyze the event, detect sensor status, store the event in memory and report the event if programmed to do so.

Another sensor with minimal power consumption can be the temperature sensor 202. Recent research in semiconductor technology has produced a sensor with low power and leakage currents in the order of picoamps using tunneling effects. This is the result of research by Hui Wang and Patrick Mercier Near-Zero-Power Temperature Sensing via Tunneling Currents Through Complementary Metal-Oxide-Semiconductor Transistors, published in the Journal Nature on Jun. 30, 2017, which can be obtained by following the url: https://www.nature.com/articles/s41598-017-04705-6.pdf

Another sensor with minimal power consumption is a humidity sensor such as embodiments made by the company Sensirion (sensirion.com). This integrated component uses 500 picoamps of current. Similarly, there are other sensors that use micromechanical systems that undergo a change of a physical and electronic parameter that are used to detect pressure, motion, and shock with use of power supply currents in the order of hundreds of picoamps.

The Electronic Monitoring Unit 200 may be operated at a low power in sleep mode and can be woken up by a sensor similar to the sensors mentioned above. The MCU controller 206 operates in such a manner that if any of the input output ports are connected to a logic high, the unit can remain in sleep mode. Conversely, if any of the input pins experience a logic low then this will wake up the MCU controller 206 and it will then execute the internal program in firmware. Therefore, if one of the sensors detects an event, the sensor will activate an input line 210, 211, 212, 213, 214, which will wake up and interrupt the MCU 206. The MCU 206 will then assess the detected signal from the sensor and will log in the event in non-volatile memory including the value of the sensor signal and a time stamp. The time stamp is a feature that is internally provided in the MCU 206 with the use of an internal timer.

The Electronics Monitoring Unit 200 may further comprise a touch sensitive sensor 208. In one embodiment, if the user places a finger on top of the sensor 208, the resistance between the conductive strip elements will be reduced, the power supply voltage from the battery 209 will then be applied to input pin at 216 which also wakes up the processor 206. Upon detecting the interrupt on pin at 216, the MCU 206 will then proceed to turn on the display to indicate the status (current and/or historical status) of the sensors. For example, the MCU controller 206 can turn on the LED 207 and use any of the available color settings of the LED 207 package. In the same manner, the MCU controller 206 can activate diverse types of devices that will indicate status with light or color. Turning on the LED 207 can indicate to the user if an intrusion has been detected in the past during shipment, or if one of the sensors indicates the threshold of acceptance for a sensor was exceeded. This indicator approach has the advantage of providing the user with a straightforward way to determine the status of the shipment while at the same time avoiding battery power consumption. For example, if tampering has not occurred, the green LED can be temporarily turned on. If tampering or intrusion has occurred in the past during shipment of the container, then the red LED can be turned on. The touch sensitive sensor 208 function can also be implemented with a temporary push button switch or any other on off switch.

All events processed by the MCU 206 in response to the sensors and including a time stamp when events occurred may be additionally stored in the RFID tag 215. This provides alternative means to have the user determine the history of the shipment and to see if any sensors' thresholds were exceeded. This is done by using an RFID reader that is attached to a laptop or PC or alternatively using an RFID reader that is container in a mobile phone. With the reader reporting option, it is possible to obtain and display graphs that show the performance of the security shipment over time.

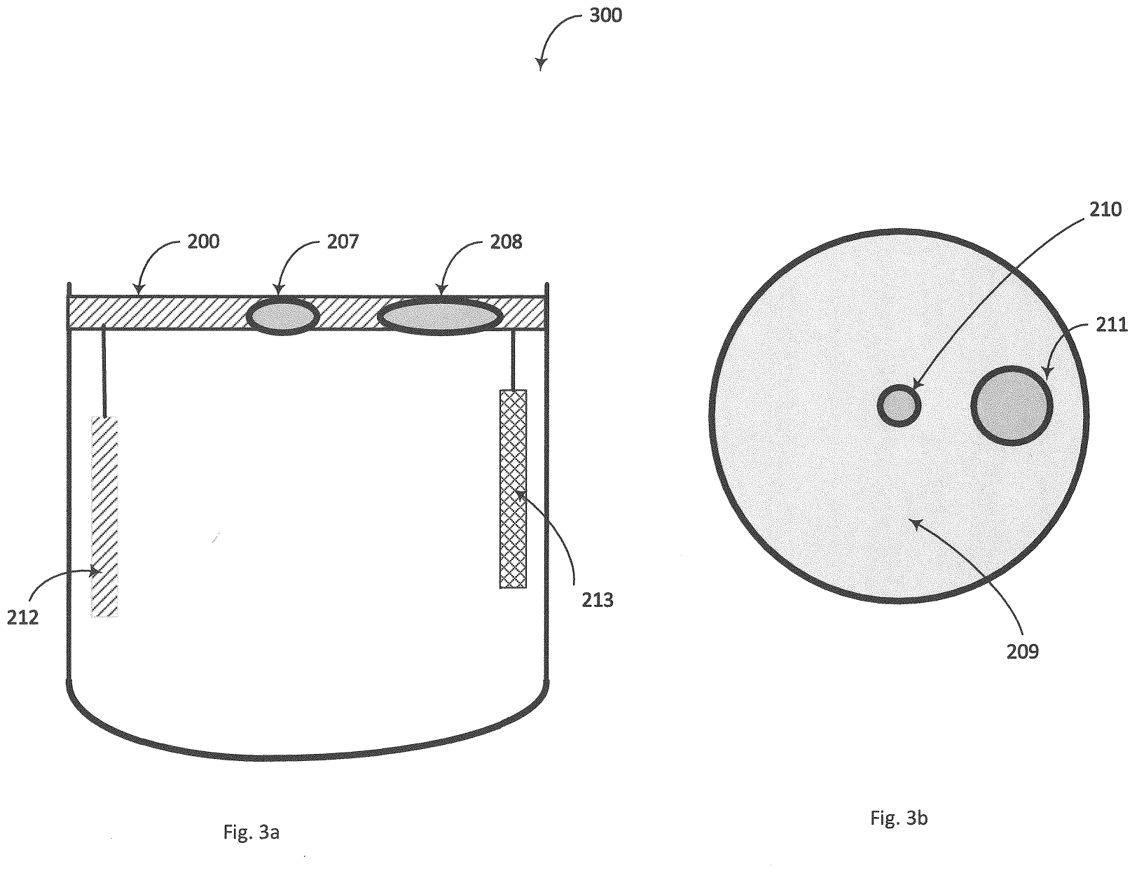

FIGS. 3a and 3b show an exemplary shipping container 300. FIG. 3b shows construction of a cap that is placed on the cylinder 202 in order to secure the goods inside. FIG. 3a shows the placement of the printed circuit board containing the Electronics Monitoring Unit 200. This figure shows an LED 207, and a touch sensor pad 208. The Electronics Monitoring Unit 200 is protected with a cover plate shown in FIG. 3b at 209. The cover plate has an opening at 210 to show the LED 207, and a second opening at 211 exposes the touch sensor 208. Terminals 212 and 213 are used to connect to a wire sensor wrapped around the cylinder 202 which is used to detect tampering of the container.

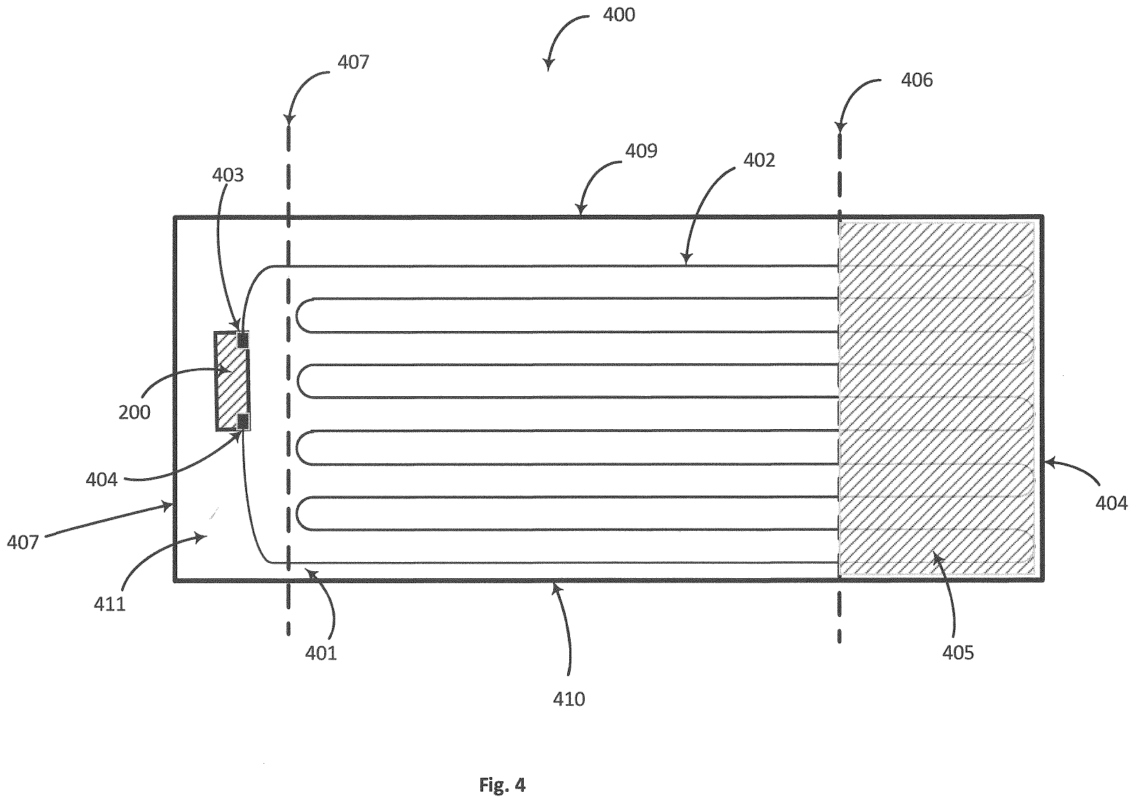

FIG. 4 shows an alternative package 400 that include the sensor and security features previously presented for a cylinder container. The alternative configuration is in the form of a bag comprising a base material shown at 401. The base material can be paper-based or plastics. On top of the base material there is a continuous pattern of traces 402 made of wire, printed conductor, semiconductor, or carbon ink which is placed on the substrate starting and ending on the Electronics Monitoring Unit 200. The conductive pattern is routed on the base material and made to start on point 403, routed on the substrate using some variable pattern. The pattern is made to return to point 404 where it connects again to the Electronics Monitoring Unit 200.

This wire is used as a sensor to detect intrusion if the wire is ever cut. A second layer of an insulating material 405 can be placed on top of the wire. The diagram illustrates only a portion of the second layer covering the wire; however, this second layer or material can extend from point 406 to point 407 covering the entire conductive pattern. This step accomplishes the goal of embedding the wire or conductive pattern in the structure of the container bag. The package assembly is completed by folding over the assembly from the right side 404 towards side 407 so the entire container is divided in half to reach location 407. The container is then sealed by means of an adhesive on sides 409 and 410 to prevent intrusion from the sides of the bag. After securing sides 409 and 410, a small opening on side 407 will remain where the goods are placed in the bag prior to shipment. The strip in section 411 containing the Electronics Monitoring Unit 200, can be covered with an adhesive and then a tape that does not bind to the adhesive is placed on top of the adhesive to cover the adhesive in preparation for the user. During use, the goods are placed in the bag in opening at 407, then the user pulls away the tape, exposing the adhesive on the flap 411. The flap can then be folded in a way that flap 411 will be glued to the rest of the container to seal the opening.

### General Interpretive Principles for the Present Disclosure

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the disclosure. For example, a system or an apparatus may be implemented, or a method may be practiced using any one or more of the aspects set forth herein. In addition, the scope of the disclosure is intended to cover such a system, apparatus or method which is practiced using other structure, functionality, or structure and functionality in addition to or other than the various aspects of the disclosure set forth herein. It should be understood that any aspect disclosed herein may be set forth in one or more elements of a claim. Although some benefits and advantages of the preferred aspects are mentioned, the scope of the disclosure is not intended to be limited to particular benefits, uses, or objectives. The detailed description and drawings are merely illustrative of the disclosure rather than limiting, the scope of the disclosure being defined by the appended claims and equivalents thereof.

With respect to the use of plural vs. singular terms herein, those having skill in the art can translate from the plural to the singular and/or from the singular to the plural as is appropriate to the context and/or application. The various singular/plural permutations may be expressly set forth herein for sake of clarity.

When describing an absolute value of a characteristic or property of a thing or act described herein, the terms “substantial,” “substantially,” “essentially,” “approximately,” and/or other terms or phrases of degree may be used without the specific recitation of a numerical range. When applied to a characteristic or property of a thing or act described herein, these terms refer to a range of the characteristic or property that is consistent with providing a desired function associated with that characteristic or property.

In those cases where a single numerical value is given for a characteristic or property, it is intended to be interpreted as at least covering deviations of that value within one significant digit of the numerical value given.

If a numerical value or range of numerical values is provided to define a characteristic or property of a thing or act described herein, whether or not the value or range is qualified with a term of degree, a specific method of measuring the characteristic or property may be defined herein as well. In the event no specific method of measuring the characteristic or property is defined herein, and there are different generally accepted methods of measurement for the characteristic or property, then the measurement method should be interpreted as the method of measurement that would most likely be adopted by one of ordinary skill in the art given the description and context of the characteristic or property. In the further event there is more than one method of measurement that is equally likely to be adopted by one of ordinary skill in the art to measure the characteristic or property, the value or range of values should be interpreted as being met regardless of which method of measurement is chosen.

It will be understood by those within the art that terms used herein, and especially in the appended claims (e.g., bodies of the appended claims) are intended as “open” terms unless specifically indicated otherwise (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

In those instances where a convention analogous to “at least one of A, B, and C” is used, such a construction would include systems that have A alone, B alone, C alone, A and B together without C, A and C together without B, B and C together without A, as well as A, B, and C together. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include A without B, B without A, as well as A and B together.”

Various modifications to the implementations described in this disclosure can be readily apparent to those skilled in the art, and generic principles defined herein can be applied to other implementations without departing from the spirit or scope of this disclosure. Thus, the disclosure is not intended to be limited to the implementations shown herein but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

What is claimed is:

1. A shipping container comprising:
a body;
one or more sensors coupled to the body, wherein the one or more sensors comprise an intrusion sensor; and
an electronics monitoring unit coupled to the one or more sensors;
wherein the electronics monitoring unit is configured to transition from a low power operational mode in response to an event detected by at least one of the one or more sensors.

2. The shipping container of claim 1, wherein the event comprises a tampering event detected by the intrusion sensor.

3. The shipping container of claim 1, wherein the one or more sensors comprise a temperature sensor.

4. The shipping container of claim 3, wherein the event comprises a temperature excursion event detected by the temperature sensor.

5. The shipping container of claim 1, wherein the one or more sensors comprise a motion sensor.

6. The shipping container of claim 5, wherein the event comprises an acceleration excursion event detected by the motion sensor.

7. The shipping container of claim 1, wherein the intrusion sensor comprises a conductive wire.

8. The shipping container of claim 1, wherein the electronics monitoring unit comprises a touch sensitive switch configured to generate a sensor status indication when activated by a user.

9. The shipping container of claim 1, wherein the electronics monitoring unit comprises a display configured to display a sensor status indication.

10. The shipping container of claim 1, wherein the shipping container is a bag or envelope.

11. The shipping container of claim 1, wherein the shipping container is a cylinder.

12. The shipping container of claim 11, wherein the electronics monitoring unit is coupled to a lid of the container.

13. A method of monitoring a status of a shipping container comprising:
coupling one or more sensors to the shipping container;
coupling the one or more sensors to an electronic monitoring unit;
in a low-power mode of the electronic monitoring unit, monitoring one or more outputs from the one or more sensors;
in response to an event detected via at least one of the one or more outputs, transitioning from the low-power mode to a higher power mode.

14. The method of claim 13, comprising recording outputs from the one or more sensors by the electronics monitoring unit in the higher power mode.

15. The method of claim 13, wherein the event detected comprises an intrusion.

16. The method of claim 13, wherein the event detected comprises a temperature excursion.

17. The method of claim 13, wherein the event detected comprises an acceleration excursion.

18. The method of claim 13, comprising displaying an indication of sensor status in response to a user actuating a switch on the shipping container.
